(19) United States
(12) Patent Application Publication
(10) Pub. No.: US 2003/0019700 A1
(43) Pub. Date: Jan. 30, 2003

(54) Magnetorheological fluid damper

(76) Inventor: Michael Wittig, Mountain View, CA (US)

Correspondence Address: MICHAEL WITTIG, 355 MARIPOSA AVE #5, MOUNTAIN VIEW, CA, 94041, US

(21) Appl. No.: 10/205,514

(22) Filed: Jul. 25, 2002

Related U.S. Application Data
(60) Provisional application No. 60/307,983, filed on Jul. 25, 2001.

(51) Int. Cl. F16F 9/53

(52) U.S. Cl. 188/267.2

(57) ABSTRACT

A radial magnetorheological damper is provided which includes a plurality of alternating inner and outer sleeves, a magnetorheological fluid interspersed between them, a return path to return magnetic flux, and a wire coil to produce magnetic flux in the circuit.

### CROSS-REFERENCE TO RELATED APPLICATIONS

This application claims the benefit of U.S. Provisional Application No. 60/307,983, filed on Jul. 25, 2001, the entire disclosure of which is hereby incorporated by reference herein.

### BACKGROUND OF THE INVENTION

1) Field of Invention

This invention relates to magnetorheological fluid dampers.

2) Discussion of Related Art

Magnetorheological fluid dampers are used as a controllable means of damping motion.

### SUMMARY OF THE INVENTION

In accordance with one preferred embodiment, a radial magnetorheological damper is provided which includes a plurality of alternating inner and outer sleeves, a magnetorheological fluid interspersed between them, a return path to return magnetic flux, and a wire coil to produce magnetic flux in the circuit.

### BRIEF DESCRIPTION OF THE DRAWINGS

The invention is described by way of examples with reference to the accompanying drawings wherein:

FIG. 1 is a cross-sectional view of the preferred embodiment of the invention.

FIG. 2 is a detail view of section A from FIG. 1

FIG. 3 is a cross-sectional view of the preferred embodiment of the invention, as was shown in FIG. 1.

FIG. 4 is a perspective view of the preferred embodiment of the invention, as was shown in FIG. 1.

FIG. 5 is a cross-sectional view of an alternative embodiment of the invention.

FIG. 6 is a cross-sectional view of a second alternative embodiment of the invention.

FIG. 7 is a perspective view of the return path and coil for the second alternative embodiment of the invention illustrated in FIG. 6.

FIG. 8 is a diagram view of an alternative means of returning magnetic flux in the radial configuration of the invention.

FIG. 9 is a schematic view of how a coil is controlled when controlling a magnetorheological fluid.

### DETAILED DESCRIPTION OF THE INVENTION

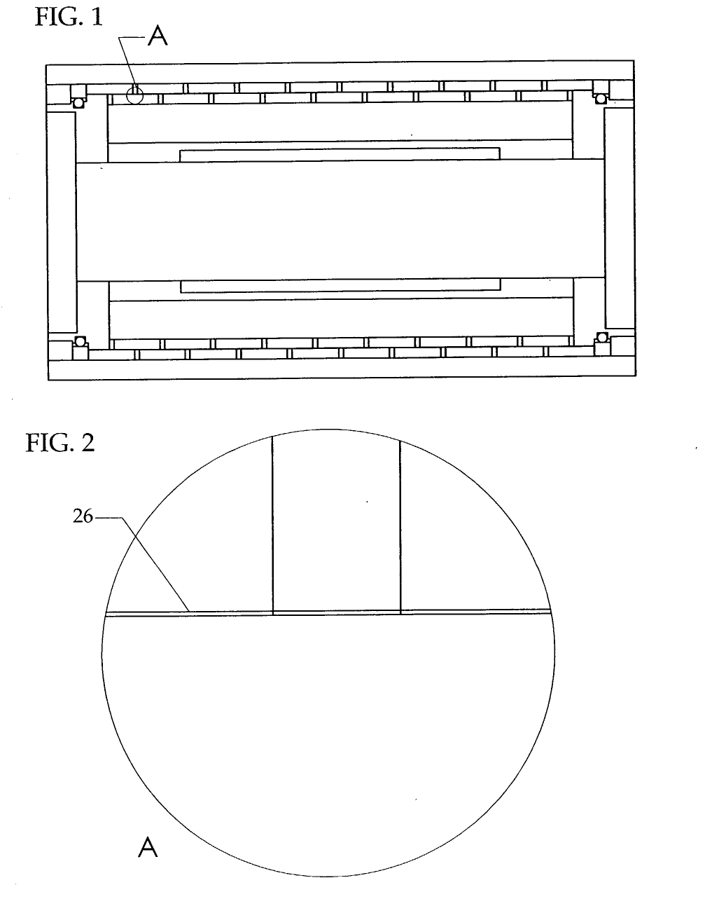

FIG. 1 of the accompanying drawings illustrates the preferred embodiment of the invention. Section A of FIG. 1 is shown in FIG. 2. Fluid gap 26 as shown in FIG. 2 contains magnetorheological fluid, such as part number MRF-132AD of Lord Corporation of Cary, N.C.

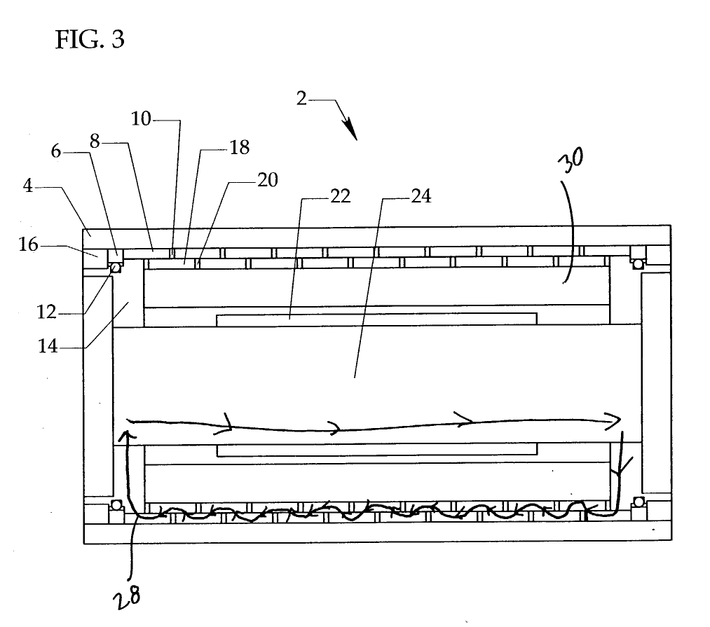

FIG. 3 illustrates the details of the invention. Radial magnetorheological damper 2 is surrounded by a housing 4 which is preferably made of a nonmagnetic material such as aluminum. Ball bearing 16 fits within housing 4 and supports endpiece 14. Endpiece 14 is preferably of a material that has a high magnetic saturation flux density and high magnetic permeability such as steel. Outer sleeves 8 are separated by outer spacers 10, while inner sleeves 18 are separated by inner spacers 20. Outer sleeves 8 and inner sleeves 18 are preferably of a material that has a high magnetic saturation flux density and high magnetic permeability such as steel. Wire coil 22 wraps around magnetic return path 24 and is a preferably made of a conductive material like copper. Magnetic return path 24 snugly fits into endpiece 14. Magnetic path 28 illustrates how magnetic flux travels in the device from the magnetic return path 24 to an endpiece, through the outer sleeves and inner sleeves in an alternating fashion, and back through a second endpiece to return to magnetic return path 24. Outer sleeves 8 and outer spacers 10 are rigidly attached to housing 4. This can be done with an adhesive, a press-fit, or other standard means of fashioning. In the preferred embodiment, the sleeves and spacers are attached with adhesive. Inner support 30 is rigidly attached to endpiece 14. It is preferably made of a nonmagnetic material such as aluminum.

The invention works by generating a shear force in the magnetorheological fluid between surfaces that move relative to one another. In the preferred embodiment, a shear force is developed between outer sleeves 8 and inner sleeves 18 as the magnetic field travels roughly perpendicularly across sleeve pairs. When endpiece 14 is rotated, inner sleeves 18, inner spacers 20, inner support 30, magnetic return path 24, the inner race of ball bearings 16, and wire coil 22 all rotate together. When housing 4 is fixed, outer sleeves 4, outer spacers 10, and the outer race of ball bearings 16 move together. The relative motion outer sleeves 8 and inner sleeves 18 as this occurs generates the damping force. Electrical current flows through wire coil 22. Increasing current in wire coil 22 generally increases the magnetic field traveling between outer sleeves 8 and inner sleeves 18, which increases the shear force between them. This is limited by magnetic saturation of the materials in the path taken by the magnetic field, which for steel occurs roughly around 1.8 Tesla.

O-rings 12 seal in the magnetorheological fluid. O-rings 12 squeeze between O-ring track 6 and endpiece 14. The fluid is held within the cavity between the two endpieces, specifically in the vicinity of the outer sleeves and inner sleeves. The connection between inner support 30 and endpiece 14 prevents fluid from leaking out, reaching wire coil 22 for example.

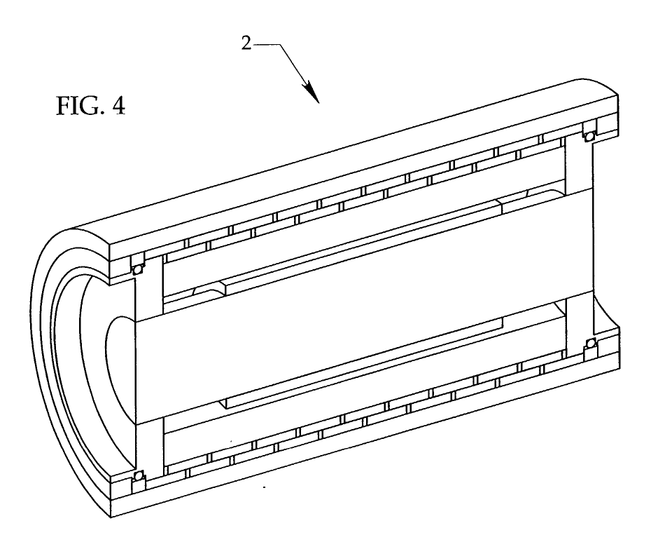

FIG. 4 is a perspective view of the preferred embodiment and shows the aforementioned components.

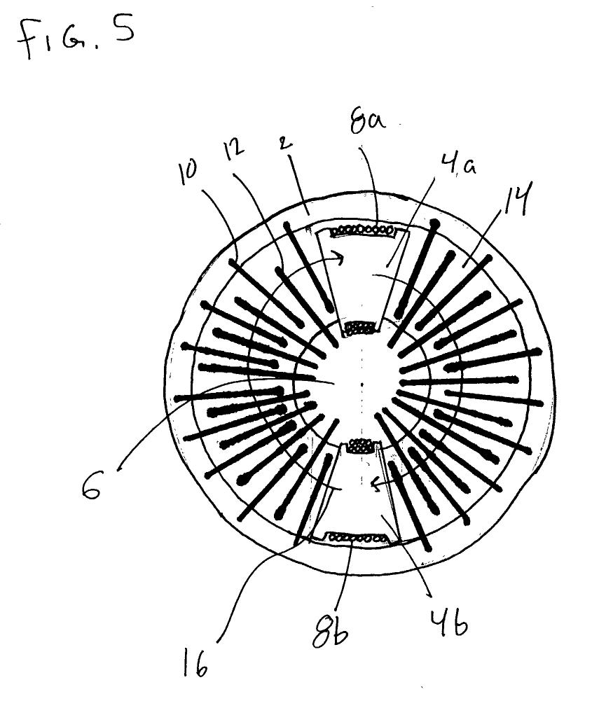

FIG. 5 is a cross-sectional view of an alternative embodiment of the invention. Housing 2 has blades 10, preferably of a soft magnetic material such as steel, pressed into it about its inner circumference. Inner blades 12 are interspersed between blades 10. Magnetic cores 4a and 4b are diametrically opposite one another and attached to shaft 6. Shaft 6 is preferably of a nonmagnetic material such as aluminum. Coils 8a and 8b are wrapped around magnetic cores 4a and 4b respectively. Magnetic field path 16 shows how the magnetic field travels when coils 8a and 8b are energized with electrical current. Shear forces are developed between blades 10 and inner blades 12 as a result a of a magnetic field moving roughly perpendicular to the blades. Increasing current in coils 8a and 8b corresponds to increasing shear forces, until the magnetic circuit saturates.

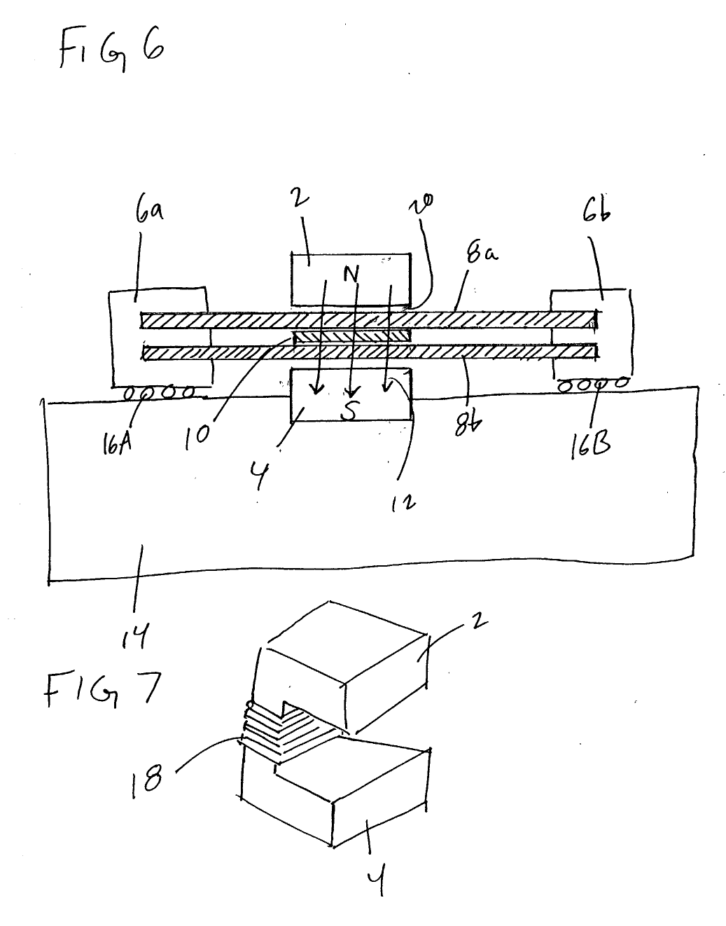

FIG. 6 shows a second alternative embodiment of the invention. Pole piece 2 and pole piece 4 are joined by a return path with a coil wrapped around it, as shown in FIG. 7. Energizing wire coil 18 with electric current produces magnetic flux 12 that travels from pole piece 2 to pole piece, across plates 8a, 8b, and inner plate 10. Magnetic fluid 20 is interspersed between plates 8a, 8b, and inner plate 10. Supports 6a and 6b rigidly join and space out plates 8a and 8b. Supports 6a and 6b are on rollers 16a that allow free travel of plates 8a, 8b, and supports 6a and 6b relative to baseplate 14. Increasing current in wire coil 18 generally increases the shear force in magnetic fluid 20 until the magnetic field saturates.

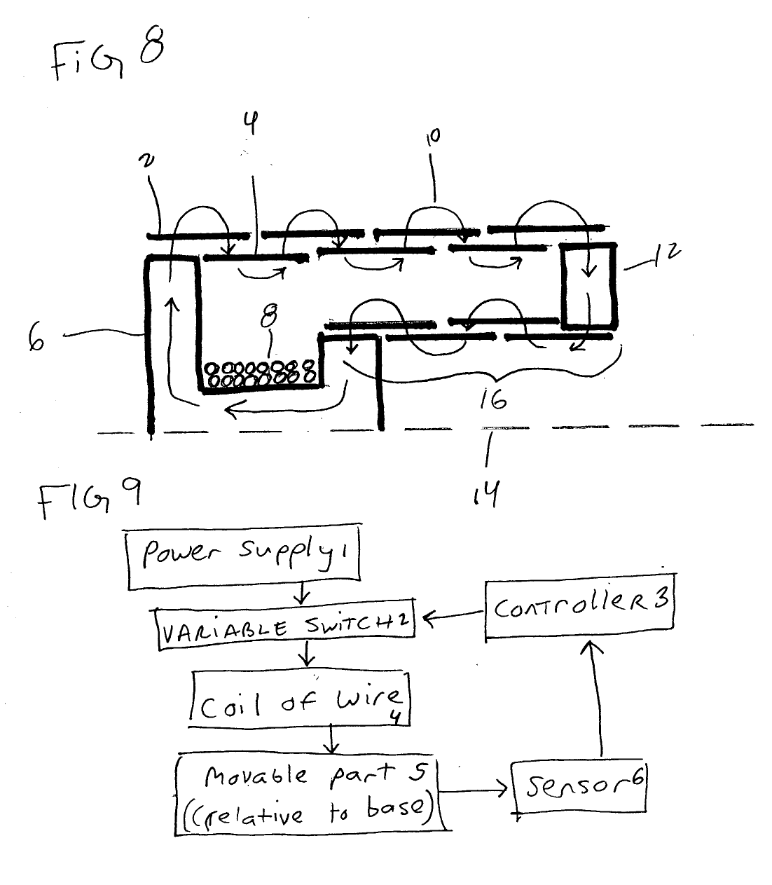

FIG. 8 illustrates an alternative magnetic circuit design for the invention. Axis 14 is the axis of rotation of the device. The bottom half of the device is not shown for clarity, but is symetric with the illustrated top portion. Outer sleeves 2 and inner sleeves 4 are continued inside their main route in magnetic path section 16. Wire coil 8 creates a magnetic field that travels from endpiece 6 around the circuit as illustrated by magnetic path 10. This design reduces the length of the magnetic return path that does not contribute to magnetic fluid shear torque. Endpiece 6 is a combination of the end endpiece 14 and magnetic and magnetic return path 24 of FIG. 3, but there are more shear force producing pairs of outer sleeves and inner sleeves for a given device length. This comes at the expense of added device complexity.

FIG. 9 is a schematic diagram of how the wire coil of the various embodiments is controlled. Variable switch 2 supplies power from power supply 1 to coil of wire 4 under the control of controller 3. Coil of wire 4 produces a magnetic field which in turn creates shear forces between the fixed base (relatively speaking) of the device and the movable part 5. Sensor 6, such as a position or velocity sensor, returns data to controller 3 to aid in the control of the device.

It should be understood that other embodiments are possible without departing from the scope and spirit of the invention.

What is claimed:

1. A magnetorheological fluid damper including:
a plurality of surfaces;
a second plurality of surfaces;
a magnetorheological fluid interspersed between the surfaces;
and a return path, wherein magnetic flux travels in between surface pairs generally in a perpendicular manner but also travels in a direction perpendicular to that direction within the surfaces.
